(19) United States
(12) Patent Application Publication
(10) Pub. No.: US 2014/0285531 A1
(43) Pub. Date: Sep. 25, 2014

(54) SYSTEM, METHOD, AND DEVICE FOR ADJUSTING DISPLAY LUMINANCE

(71) Applicant: ERICSSON TELEVISION INC., Duluth, GA (US)

(72) Inventor: Charles Hammett Dasher, Lawrenceville, GA (US)

(73) Assignee: Ericsson Television Inc., Duluth, GA (US)

(21) Appl. No.: 13/847,334

(22) Filed: Mar. 19, 2013

(51) Int. Cl. G09G 5/10

(52) U.S. Cl. CPC G09G 5/10
USPC 345/690

(57) ABSTRACT

A system, method, and device for adjusting display luminance based upon luminance control information associated with content being presented on a display associated with a computing device. A luminance module in the computing device determines luminance control information for the content. The luminance control information is used to control a luminance of a display. The luminance control information corresponds to brightness values of the content. A display driver adjusts a luminance of the display during presentation of the content based upon control signals received from the luminance module. The luminance module uses the luminance control information to generate the control signals.

### TECHNICAL FIELD

The disclosure relates generally to computing devices and systems that display content. More particularly, but not by way of limitation, the disclosure is directed to a system, method, and device for adjusting display luminance based upon brightness of content being presented on a display associated with a computing device.

### BACKGROUND

The display of content by a computing device, such as a mobile computing device, often requires the consumption of power (e.g., battery life), which is often a limited quantity on such devices. A graphics processing unit is utilized to generate representations of content that are displayed via a computing device such as a monitor or screen. Additionally, a display driver is utilized to control the luminance of the display of the device.

In some instances, the display driver is configured to adjust the luminance of the display based upon information received from a power conservation application that measures available power for the computing device, as well as current power consumption by the display of the computing device. When the remaining power for the computing device falls below a threshold power level, the power conservation application automatically dims the display to reduce current power consumption and extend battery life. The power conservation application may progressively dim the display even if the user continues to use the computing device to display content.

### SUMMARY

The present disclosure provides a system, method, and computing device for automatically adjusting a luminance of a display based upon luminance control information of content being presented to the display by a computing device, which is associated with the display.

One embodiment of the present disclosure provides a method of adjusting a luminance of a display of a computing device based upon luminance control information of content presented on the display. The method includes determining by a luminance module in the computing device, luminance control information for the content. The luminance control information is used to control a luminance of a display. Additionally, the luminance control information corresponds to brightness values of the content. The method includes adjusting by a display driver in the computing device, a luminance of the display during presentation of the content using the luminance control information.

In one embodiment, the luminance control information is embedded into the content as metadata, and the step of determining luminance control information includes reading by the luminance module, the luminance control information from the metadata of the content.

In another embodiment, the method includes receiving by a content buffer of the computing device, the content from a network.

In another embodiment, the method includes receiving by the luminance control module of the computing device, the luminance control information from the network on a control channel.

In another embodiment, the luminance control information is specified by a content author.

In another embodiment, the method also includes determining an ambient light level proximate the display via an ambient light sensor, as well as calculating an ambient light scaling factor by the luminance module. Additionally, the method includes modifying by the display driver, the luminance of the display based upon the ambient light scaling factor.

In another embodiment, the present disclosure provides a method of adjusting a luminance of a display based upon content brightness of content stored by a computing device associated with the display. The method includes scanning by a luminance module, content segments of the content to determine brightness values of the content segments. The content segments are streamed to a buffer of the computing device. The method also includes calculating by the luminance module, luminance control information for the content from the brightness values of the content segments. The luminance control information is used to control a luminance of a display. In some instances, the method includes adjusting by a display driver a luminance of the display during presentation of the content segments based upon on the luminance control information.

In one embodiment, determining luminance control information for the content comprises generating by the luminance module, a brightness profile for the content and generating a luminance script from the brightness profile. The method includes executing the luminance script by the luminance module to cause the display driver to adjust the luminance of the display while a content player application executing on the computing device presents the content for display.

In one embodiment, the luminance script is keyed to time stamps of the content such that as the luminance module executes the luminance script the luminance module causes the display driver to adjust the luminance of the display at each of the time stamps, wherein each of the time stamps comprises a luminance setting for the display.

In another embodiment, the present disclosure provides a computing device for adjusting a luminance of a display based upon luminance control information of content presented by the display. The computing device may include a luminance module that determines luminance control information for the content. The luminance control information is used to control a luminance of a display, and the luminance control information corresponds to brightness values of the content. A display driver adjusts a luminance of the display during presentation of the content based upon control signals received by the display driver from the luminance module. The luminance module generates the control signals from the luminance control information.

In one embodiment, the computing device includes an ambient light sensor that senses an ambient light level proximate the display. Also, the luminance module is further configured to calculate an ambient light scaling factor and modify the control signals for the display driver based upon the ambient light scaling factor.

In one embodiment, the computing device includes a content buffer that receives the content from a network on a content channel. Also, the luminance module receives the luminance control information from a network on a control channel.

In another embodiment, the present disclosure provides a system for adjusting a luminance of a display based upon luminance control information of content presented on the display. The system includes a computing device having a display driver that adjusts a luminance of the display during presentation of the content and a luminance control module that controls the display driver according to luminance control information. The luminance control information corresponds to brightness values of the content. The system also includes a network that streams the content to the computing device.

In one embodiment, the network streams the luminance control information to the luminance module on a control channel.

In one embodiment, the luminance module determines the luminance control information for the content by analyzing brightness values of images included in the content.

In one embodiment, the network generates the luminance control information by analyzing the brightness values of the images of the content.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a schematic diagram of an exemplary system in which embodiments of the present technology may be practiced;

FIG. 2 is a schematic diagram of a timeline of content illustrating time stamps associated with luminance control information;

FIG. 3 is a schematic diagram of a brightness profile of content;

FIG. 4 is a flowchart of a method for adjusting a luminance of a display of a computing device based upon luminance control information of content presented on the display;

FIG. 5 is a flowchart of a method for adjusting a luminance of a display based upon content brightness of content stored by a computing device associated with the display;

FIG. 6 is a flowchart of an exemplary method that includes generating a brightness profile and a luminance script; and

FIG. 7 is a flowchart of an exemplary method for modifying the luminance of a display using an ambient light scaling factor.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the present technology. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally, the present disclosure is directed to devices, systems, and methods for automatically adjusting a luminance of a display based upon luminance control information of content being presented (or content that is queued to be presented) by a computing device.

Content presented by a computing device, in accordance with the present technology, may include, but is not limited to video content such as a television program, a movie, a videogame, and the like, as well as photographic content such as still photographs, a slideshow of photographs, and other images. Content contemplated for use with the present technology may include other content types of similar to the types of content described above. It will be understood that the content may comprise any media that can be displayed on a display of a computing device, so long as the media is provided with luminance control information, or the content can be evaluated for brightness values of data included in the content. For example, a movie may include various frames (e.g., image files) that either comprise luminance control information embedded therein. Alternatively, the frames may be evaluated to determine a brightness value for each of the frames. The brightness values of the frames may be used to generate luminance control information, as will be discussed in greater detail below.

Devices that employ power conservation features often utilize an application that measures available power (e.g., battery life). The application informs the display driver to adjust the luminance of the computing device based upon information received from a power conservation application that measures available power for the device, as well as current power consumption by the display of the computing device. When the available power for the device falls below a threshold power level, the power conservation application automatically dims the display to reduce current power consumption and extend battery life. The power conservation application may progressively dim the display if the user continues to use the computing device, further depleting available battery life.

While these features are advantageous for conserving battery life, these features sacrifice viewing quality for the display, especially when the content being displayed includes low brightness content. For example, a movie may include various scenes with low brightness content, such as scenes filmed at night, or in dark locations. Automatic adjustment of display luminance without regard to the brightness or relevance of the content being displayed fails to provide the user with a quality viewing experience.

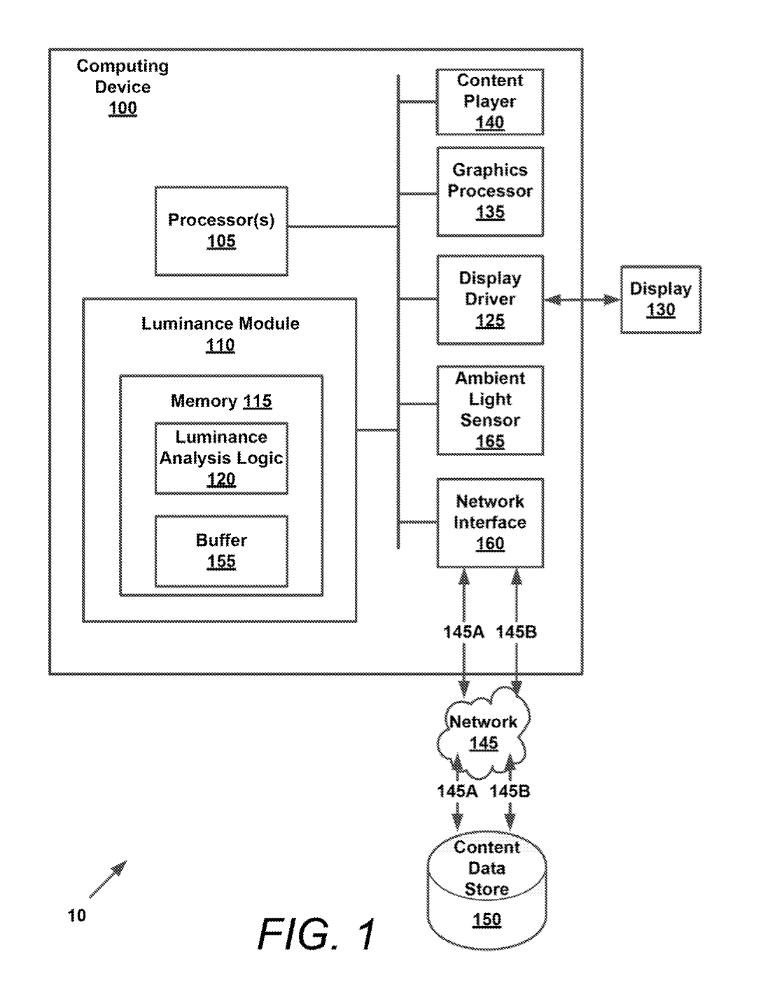

FIG. 1 illustrates a system 10 for adjusting display luminance in accordance with an embodiment of the present invention. The system 10 includes a computing device 100, a display 130, a network 145, and content data store 150. Computing device 100 (along with display 130) can be implemented, for example, as a cellular telephone, a tablet computer, a television, a computer monitor, a laptop computer, or a desktop computer. Computing device 100 includes a processor 105, which is coupled to a luminance module 110, a display driver 125, a graphics processor 135, a content player 140, a network interface 160, and an ambient light sensor 165, all described herein in more detail.

Processor 105 can be implemented as at least one microprocessor with one or more processing cores. Processor 105 can be implemented as a core processor that services one or more of the components of computing device 100. Alternatively, processor 105 can include at least one dedicated microprocessor for the luminance module 110.

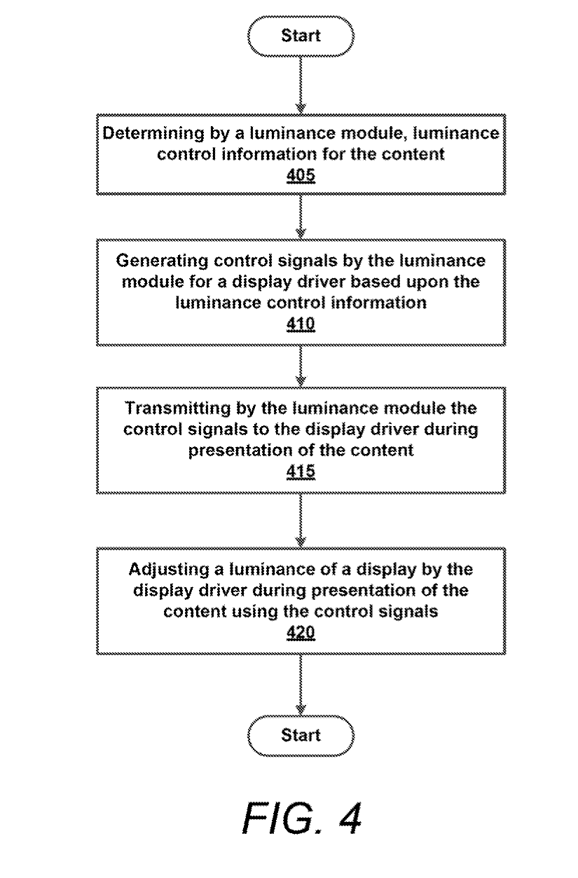

As illustrated, luminance module 110 includes a memory 115, which further includes a luminance analysis logic 120, and a buffer 155. As used herein, the term “module” can refer to an application-specific integrated circuit (ASIC), a system-on-a-chip (SOC), a microcontroller, an electronic circuit, a microprocessor (shared, dedicated or group) that executes one or more software or firmware programs, a combinational logic circuit, and/or suitable components that provide the described functionality. Also, luminance module 110 can also be implemented as computer-readable instructions stored in a computer-readable storage medium (e.g., main memory such as a read-only memory (ROM), a random-access memory (RAM), a hard disk drive (HDD), and/or a solid state drive (SSD)). When executed by processor(s) 105, the computer-readable instructions implement the methods of the present invention described in more detail in conjunction with FIGS. 4-7.

The display driver 125 controls a display 130 of the computing device 100. In accordance with the present technology, the luminance module 110 controls the luminance of the display 130 by providing control signals to the display driver 125.

The content player 140 may include an application that is configured to play one or more types of content, such as video files or other media. The content player 140 may include a dedicated content player that resides on the computing device 100, or may include a content player that executes within a web browser client application of the computing device 100.

The network interface 160 may comprise any component, or combination of components that allow the computing device 100 to communicatively couple (e.g., facilitate data transfer) with other computing devices or networks, such as a network 145. The network interface 160 may comprise an Ethernet port, a wireless module or adapter, or any other interface that would be known to one of ordinary skill in the art with the present disclosure before them.

The computing device 100 may transmit and receive content data and luminance control information from a content data store 150 that is accessible by the network 145. In some instances, the computing device 100 may receive content data from the content data store 150 on a content channel 145B. The computing device 100 may also receive luminance control information from the content data store 150 on a control channel 145A. The computing device 100 may in some embodiments include an ambient light sensor 165 that senses ambient light levels proximate the display 130. The ambient light sensor 165 may output ambient light level signals to the luminance module 110, which utilizes the ambient light level signals to determine an ambient light scaling factor, which is used by the luminance module 110 to modify the luminance of the display 130. Thus, the luminance module 110 may both adjust the luminance of the display 130 according to brightness values of the content being presented by the display 130 and correct or modify the luminance of the display 130 using the ambient light scaling factor.

As used herein, the term “module” may also refer to any of an application-specific integrated circuit (ASIC), system on a chip (SOC), a microcontroller, an electronic circuit, a processor (shared, dedicated, or group) that executes one or more software or firmware programs, a combinational logic circuit, and/or other suitable components that provide the described functionality. Thus, the processor 105 may include a core processor that services one or more of the components of the computing device 100. Alternatively, the processor 105 may include a dedicated processor for the luminance module 110. Additionally, the luminance analysis logic 120 may be stored in a main memory of the computing device 100, as opposed to a dedicated memory store.

When executed by the processor 105, the luminance analysis logic 120 causes the luminance module 110 to determine luminance control information for content provided to a computing device 100. It will be understood that in some embodiments the luminance control information specifies luminance settings for the display of the computing device during presentation of the content. More specifically, the luminance settings are used by a display driver 125 to control the luminance of a display 130. It will be understood that the luminance of a display 130 may colloquially be referred to as the “brightness” of the display.

The term “luminance” may be understood to comprise an amount of light that passes through or is emitted from a particular area, such as the display 130. More specifically, luminance is measured as an intensity of light emitted from a surface per unit area in a given direction. The term “brightness” may be understood to include a location of a visual perception along a continuum from black to white.

Indeed, the luminance of the display 130 is the amount of light that is emitted from the surface area of the display 130. Therefore, the amount of light that is emitted from the surface area of the display 130 is correlated to the location along the black to white continuum of the content that is being presented on the display 130. For example, content that includes a brightness that skews towards the black portion of the black to white continuum may be correlated with a greater luminance value than content that includes a brightness that skews towards the white portion of the black to white continuum. Advantageously, darker content having brightness values that skew towards the black portion of the black to white continuum may be more optimally presented on a display that is set to a higher luminance.

The display 130 may comprise a monitor that is associated with a computing device, such as a laptop. Also, the display 130 may comprise a transparent display that is utilized in accordance with devices such as intelligent glasses or head's up displays. In one embodiment, the present technology may be employed to control the luminance display screen lenses used in intelligent glasses. The luminance of display screen lenses may be controlled by the user who sets a maximum brightness threshold, which may be applied during playback of content to reduce the luminance of the display screen lenses when the brightness values of the content being displayed reach the maximum brightness threshold. Users may advantageously change the maximum brightness threshold to suit their preferences.

In additional embodiments, the luminance module 110 may be configured to adjust a transparency of content provided on the display 130. For example, the display 130 comprises a pair of transparent displays, such as a transparent liquid crystal displays used as glasses lenses. The transparency of content that is displayed on these glasses lenses may be adjusted by the luminance module 110. The luminance module 110 may adjust the transparency of the lenses such that the viewer can clearly see the content displayed, but the user cannot view objects through the lenses. Correspondingly, the luminance module 110 may allow for incremental adjustment of the transparency of the lenses such that the viewer can see the content displayed, as well as view objects through the lenses.

For example, a viewer may adjust a transparency of content provided on the display 130 in such a way that only the content is viewable on the display 130. If the viewer needs to divert their attention away from the content and view objects through the lenses, the viewer may adjust the transparency of content to a suitable level that allows the user to see through the content.

In some embodiments, the luminance control information may refer to information that is encoded or embedded into the content as metadata. This luminance control information allows a compatible device (e.g., a device having a luminance module) to control the luminance settings of an associated display. Of note, the adjustment of luminance settings or other display specific parameters is accomplished by way of the display driver 125. The display driver 125 is controlled by the luminance module 110. The luminance module 110 controls the display driver 125 in accordance with the luminance control information. More specifically, the luminance module 110 may generate control signals based upon the luminance control information. These control signals are transmitted from the luminance module 110 to the display driver 125. The display driver 125 then transmits signals to the display driver 125 to adjust the luminance settings of the display 130. It will be understood that the signals transmitted by the display driver 125 to the display 125 that adjust the luminance settings of the display are display specific.

The actual visual or graphical representations of content that are displayed by the display 130 are generated by the graphics processor 135, as would be known to one of ordinary skill in the art. As mentioned previously, the computing device 100 may comprise a content player 140, which may include an application that is configured to play one or more types of content, such as video files. The content player 140 may include a dedicated content player that resides on the computing device 100, or may include a content player that executes within a web browser client application of the computing device 100. In either case, the content player 140 provides the graphics processor 135 with content that is presented via the display 130.

In some embodiments, the luminance control information may be maintained and transmitted separately from the content. That is, rather than embedding the luminance control information into the content itself, the luminance control information may be stored on the content data store 150, or other network device.

The luminance control information may be associated with the content using track information. This track information may be embedded or encoded into the content itself. In other embodiments, the luminance control information may be executed by the luminance module 110 as the content is being presented by the display 140.

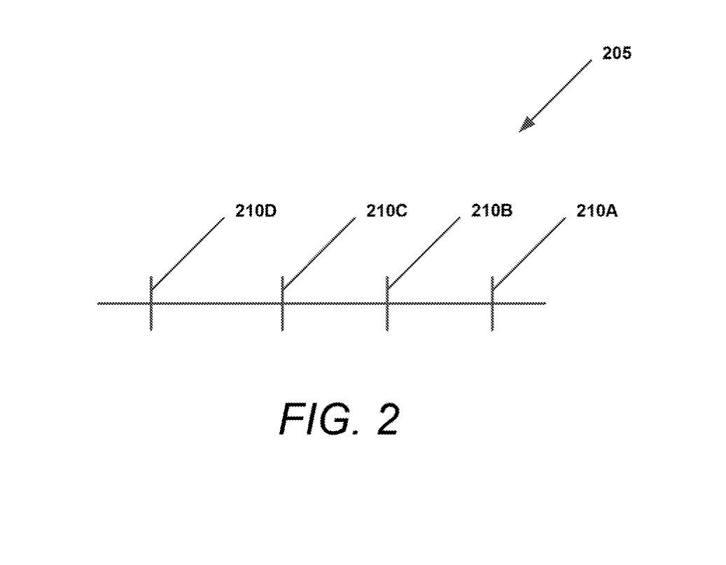

FIG. 2 illustrates an exemplary content timeline 200. The Content timeline 200 indicates includes specific time stamps 210A-D that describe various points in the running time of particular content. For example, content timeline 200 is a depiction of the running time of particular content (e.g., a movie, a television show, a video clip, or a slideshow of images). Content timeline 200 can be implemented as a graphical depiction of the running time or a list of events that can be read by the luminance module 110 as the content is rendered by the graphics processor 135 and presented by the display 130. Indeed, the luminance module 110 may utilize the content timeline as a script that informs the luminance module 110 of desired luminance settings for the display 130 during presentation of the content.

Each of the time stamps 210A-D is associated with a luminance setting. For example, time stamp 210A may include a luminance setting of 50% of the total available luminance for the display 130. As the content is played and time progresses to time stamp 210C, the time stamp 210C may include a luminance setting of 75% of the total available luminance for the display 130. Thus, the luminance control information is keyed to time stamps of the content.

In some instances, the content timeline 200 may be embodied as a script that is read by the luminance module 110 as the content is presented by the display 130. More specifically, as the content is played by the content player 140 in concert with the graphics processor 135, the luminance module 110 may read the content timeline 200 and generate control signals that are transmitted to the display driver 125. The display driver 125 communicates with the display 130 to automatically adjust the luminance of the display over time based upon the control signals received from the luminance module 110.

Again, the luminance control information includes a correlation of a brightness level of the content at a particular point in time (e.g., a time stamp). For example, when a scene or segment of content includes a brightness level that is relatively low, the luminance module 110 may cause the display driver 125 to adjust the luminance of the display 130.

For instances where luminance settings are tied to time stamps and are embedded in the content, the luminance module 110 may be agnostic to the actual brightness of the content, using the luminance settings associated with the time stamps. These instances are distinguishable from instances where the content includes no luminance control information and the luminance module 110 is executed to determine luminance control information by analyzing the brightness of the content in real time.

In another embodiment, the content may be preprocessed by a network service, such as the content data store 150 that operates on the network 145. Preprocessing by a network service may be advantageous in situations where the content that is displayed is not encoded or embedded with luminance control information or in instances where no luminance control information can be located for the content. Preprocessing by a network service may be advantageous when processing capacity for the computing device 100 is limited, making real time analysis of content brightness values impractical.

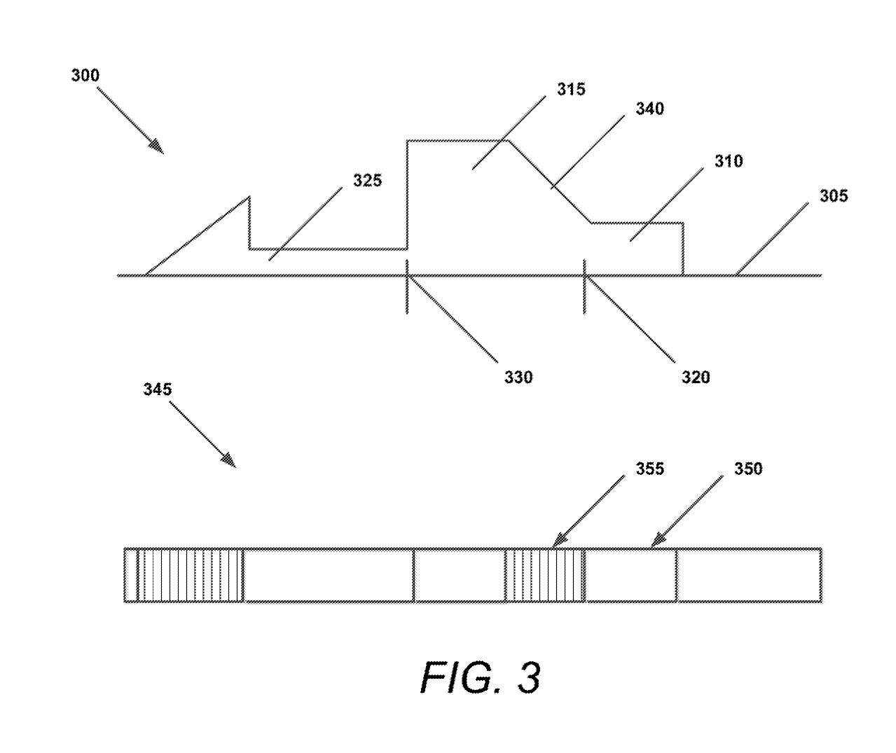

In some instances, the content is stored on the computing device 100 in memory. This may include storing the content in the main memory (not depicted) of the computing device 100, or instances where the computing device 100 accesses the content on a flash drive or DVD. In these instances, the luminance module 110 may analyze the content prior to, or in parallel, with the processing of the content via the graphics processor 135. The luminance module 110 may scan the content and generate a brightness profile (described herein in more detail in conjunction with FIG. 3) for the content. The brightness profile may be utilized by the display driver 125 to adjust the luminance of the display 130 while the content is being displayed.

The luminance module 110 may utilize the brightness profile generate a luminance script that can be keyed to specific runtime locations for the content. In one embodiment, the luminance module 110 may associate brightness changes in the brightness profile with a time stamp. The luminance module 110 may create a luminance script based upon the runtime of the content. While the content is being played, the luminance module 110 causes the display driver 125 to adjust the luminance settings of the display 130 according to the luminance script.

FIG. 3 illustrates an exemplary brightness profile 300 generated for content such as a video file, which may include a movie. The brightness profile 300 illustrates changes in content brightness values over a period of time, which is referenced by a timeline 305. Again, the brightness values may be determined by the luminance module 110 or a network service (when the content is preprocessed).

A content segment 310 is illustrated as having a lower brightness value relative to a content segment 315. The change in brightness values between content segment 310 and content segment 315 may be keyed by the luminance module 110 to a time stamp 320. Likewise, a decrease in brightness value was determined by the luminance module 110 between content segments 320 and content segments 325, which is keyed by the luminance module 110 to a time stamp 330. A transition area 340 of varying brightness values is also determined by the luminance module 110.

Using the brightness profile, the luminance module 110 may generate a luminance script 345 based upon the brightness profile 300. This luminance script may be used as luminance control information. The luminance script 345 includes a plurality of script segments, such as script segment 350. The script segments e arranged in chronological order with reference to the timeline 305.

It is noteworthy that the luminance script 345 may include script segments that include transition segments, such as transition segment 355. The transition segment 355 may correspond to the transition area 340 of the brightness profile 300. The transition segment 355 may comprise subunits that have progressively increasing or decreasing brightness values, depending upon the shape of the corresponding transition area.

During playback of the content, the luminance module 110 may generate control signals using the luminance script 345. More specifically, the luminance module 110 reads the segments in chronological order during presentation of the content and transmits control signals to the display driver 125 that cause the display driver to adjust the luminance of the display 130.

In another embodiment, the content may include luminance control information that is correlated to content relevancy, rather than, or in addition to content brightness values. For example, the luminance control information may specify that one or more segments of the content have high relevance or importance. The luminance control information may specify that the luminance settings of the display be set to a maximum allowable luminance for these important segments.

By way of example, a particular segment of a movie may be critical or highly relevant to the plot of the movie. Also, this segment takes place in a dark setting or at night, where the brightness of the scene is relatively low. The luminance module 110 may cause the display driver 125 to adjust the luminance of the display 130 to compensate for the “darkness” of the scene.

This relevancy based control of luminance settings may be leveraged for displaying content such as advertisements, where it is of paramount importance that viewers be provided with a highly viewable representation of the content.

Indeed, content authors may specify the relevance of a segment of content and encode the content with luminance control data to ensure that computing devices 100 display the content with a desired level of luminance.

It is also noteworthy that the computing device 100 may receive the content in segments over a network 145. The network 145 may comprise, for example, a content data store 150 that stores the content. The content may be streamed to a buffer 155 of the computing device 100 from the content data store 150. The buffer 155 may include an allocation of space within the memory 115 of the computing device 100.

In some embodiments, the combination of the computing device 100 and network 145 may be referred to as an HTTP (HyperText Transfer Protocol) adaptive streaming system. In an HTTP adaptive streaming system, the computing device 110 receives segments of content into the buffer 155. The luminance module 110 may process the segments/frames within the buffer 155 to determine luminance control information included in the content according to any of the processes described above.

As mentioned previously, the luminance control information may be embedded with the content as metadata. Alternatively, the network 145 may stream the luminance control information for the content on a control channel 145A established between the computing device 100 and the network 145 via a network interface 160. Indeed, the content may be streamed to the computing device 100 on a content channel 145B, while the luminance control information is streamed to the computing device 100 a control channel 145A.

In sum, the luminance module 110 may determine luminance control information for content via any one of a number of processes such as scanning the content for luminance control information encoded or embedded into the content. The luminance module 110 may also generate a brightness profile for the content, such as when no luminance control information is embedded or otherwise available to the luminance module 110. Even when the content is stored locally on the computing device 100, the luminance module 110 may determine content brightness on-the-fly by preprocessing the content using the buffer 155. That is, the luminance module 110 may load content into the buffer 155 before passing the content to the graphics processor 135. The luminance module 110 may analyze the buffered content for luminance control information.

In a variation of this concept, the luminance module 110 may be configured to detect a current luminance setting of the display 130 by interrogating the display driver 125. This current luminance setting of the display 130 may be compared to luminance control information of a portion of the content which is queued for display (e.g., in the buffer) to determine an adjustment level for the luminance setting of the display 130. The luminance module 110 may utilize the adjustment level to generate control signals that cause the display driver 125 to adjust the luminance setting of the display 130.

While luminance control information has been contemplated for use in controlling luminance of a display, the luminance control information may also specify other parameters of luminance such as display contrast, luminance contrast, and so forth.

According to some embodiments, the computing device 100 includes an ambient light sensor 165 that couples with the luminance module 110 to determine an ambient light level proximate the display 100. That is, the ambient light sensor 165 may comprise any photosensor that is configured to sense ambient light levels. An “ambient light level” may refer to an intensity of light surrounding an environment or object, such as the intensity of the light that surrounds the display 130 of the computing device 100. The ambient light level proximate the display 130 may affect viewing conditions for the user. For example, when ambient light levels are high, such as when the display 130 is positioned in direct sunlight, the ambient light level proximate the display 130 may render viewing difficult.

Using the ambient light levels sensed by the sensor 165, the luminance module 110 may calculate or determine an ambient light scaling factor. For example, the luminance module 110 may include an ambient light scaling factor index that is stored in memory 115. This index may include scaling factors which are correlated to ambient light levels. After obtaining the ambient light level data, the luminance module 110 may look up an ambient light scaling factor that corresponds to the ambient light level data.

The luminance module 110 may apply the ambient light scaling factor to the control signals that are transmitted to the display driver 125. The modification of the control signals changes the luminance setting of the display 130. Thus, the luminance of the display 130 may be adjusted not only by the luminance control information, but also by the ambient light scaling factor. For example, assuming that a content segment has luminance control information that informs the display driver 125 that the luminance setting for the display 130 should be set to 65% of total luminance for the display. if the ambient light sensor 165 detects that the computing device 100 is in a low ambient light level environment, an ambient light scaling factor may be applied to reduce the luminance setting to 55%, due to the fact that the low level of ambient light will facilitate enhanced viewing. In contrast if the ambient light sensor 165 detects that the computing device 100 is in a high ambient light level environment, an ambient light scaling factor may be applied to increase the luminance setting to 80%, due to the fact that the high level of ambient light will reduce viewing.

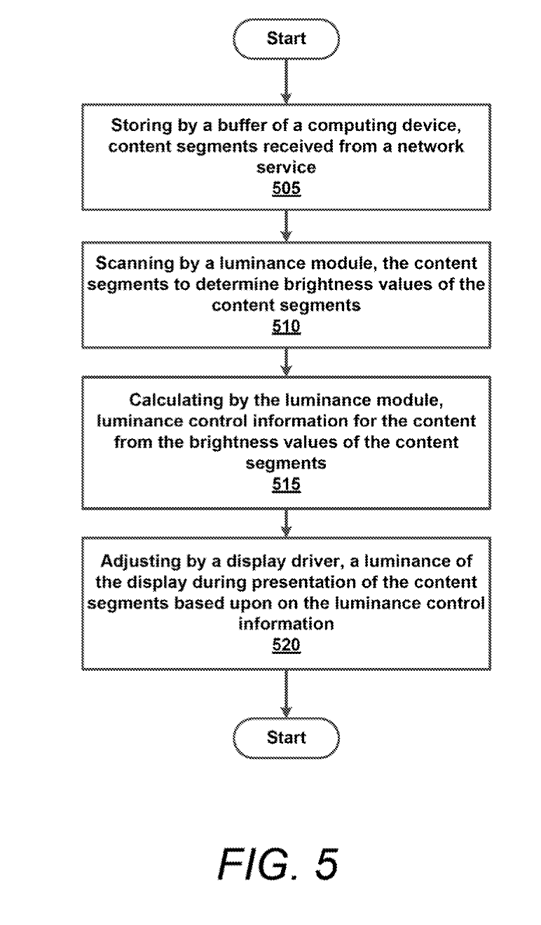

FIGS. 4-7 each illustrate methods or sub-methods for adjusting a luminance of a display of a computing device based upon luminance control information of content presented on the display. Generally, the method of FIG. 4 describes a method for adjusting a luminance of a display using luminance control information that is embedded or associate with the content, as well as instances where the luminance module evaluates brightness values of the content and generates luminance control information for the content. Alternatively, FIG. 5 describes a method for adjusting a luminance of a display for content segments stored in a buffer of a computing device, such as with HTTP adaptive streaming of content.

FIG. 4 is a flowchart of a method for adjusting a luminance of a display of a computing device based upon luminance control information of content presented on the display. The method comprises determining 405 by a luminance module in the computing device, luminance control information for the content. Again, the luminance control information is used to control a luminance of a display. Moreover, the luminance control information corresponds to brightness values of the content.

The method also comprises generating 410 control signals by the luminance module. The control signals generated by the luminance module control a display driver that, in turn, controls the display settings of the display. The method also includes 415 transmitting by the luminance module the control signals to the display driver during presentation of the content.

The method also includes adjusting 420 a luminance of the display by the display driver during presentation of the content using the control signals.

FIG. 5 is a flowchart of a method for adjusting a luminance of a display based upon content brightness of content stored by a computing device associated with the display. The method includes storing 505 by a buffer of a computing device, content segments received from a network service. The method also includes scanning 510 by a luminance module, the content segments to determine brightness values of the content segments. In some instances, the content segments are streamed to the buffer of the computing device from a network service.

The method also includes calculating 515 by the luminance module, luminance control information for the content from the brightness values of the content segments. Again, the luminance control information is used to control a luminance of a display. The luminance control information may also be processed to generate control signals that allow the luminance module to control a display driver.

The method also includes adjusting by the display driver a luminance of the display during presentation of the content segments based upon on the luminance control information.

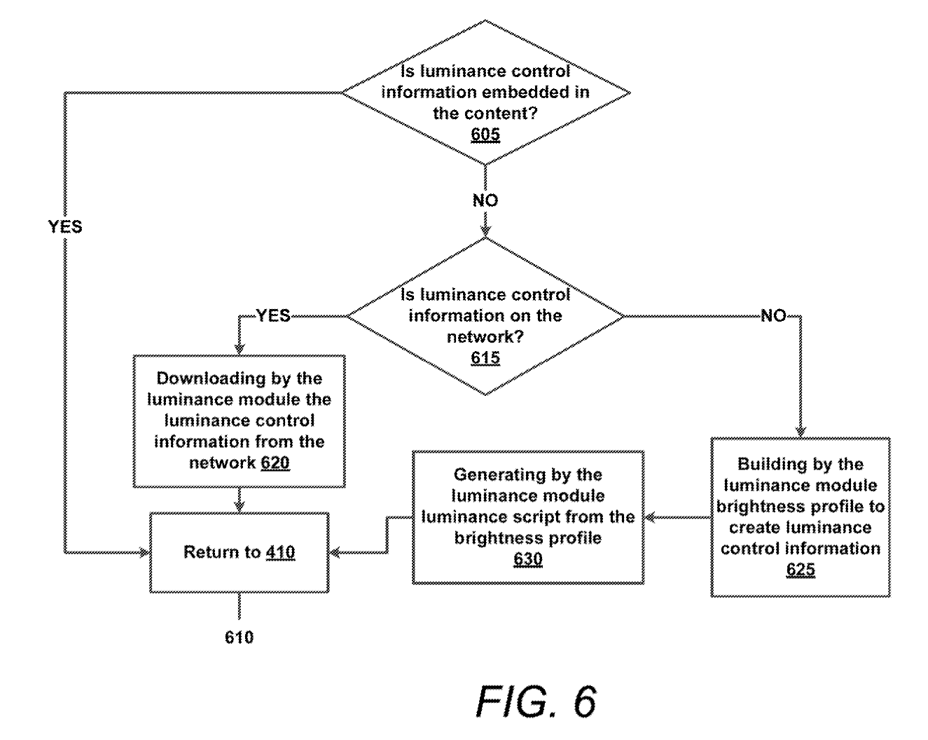

FIG. 6 is a flowchart of an exemplary method that includes generating a brightness profile and a luminance script. It will be understood that FIG. 6 is descriptive of a sub-process of determining luminance control information by the luminance module (see step 405 of FIG. 4). The method of FIG. 6 may also be applied equally to FIG. 5 as a sub-process of step 515 of calculating by the luminance module, luminance control information for the content from the brightness values of the content segments. That is, calculating luminance control information may include the method of FIG. 6.

The method includes determining 605 by the luminance module if luminance control information is embedded or encoded into the content. If the luminance information is embedded into the content, the method returns to step 410 (FIG. 4) to continue the method for adjusting a luminance of a display based upon content brightness of content stored by a computing device associated with the display.

If the luminance control information is not embedded in the content, the method includes determining 610 by the luminance module if the luminance control information is located on the network. If the luminance control information is on the network, the method includes downloading 620 by the luminance module, the luminance control information from the network before the method returns to step 410 (FIG. 4) to continue the method for adjusting a luminance of a display based upon content brightness of content stored by a computing device associated with the display.

If no luminance control information on the network, the method includes building 625 by the luminance module a brightness profile for the content to create luminance control information, as well as generating 630 by the luminance module a luminance script from the brightness profile, before the method returns to step 410 (FIG. 4) to continue the method for adjusting a luminance of a display based upon content brightness of content stored by a computing device associated with the display.

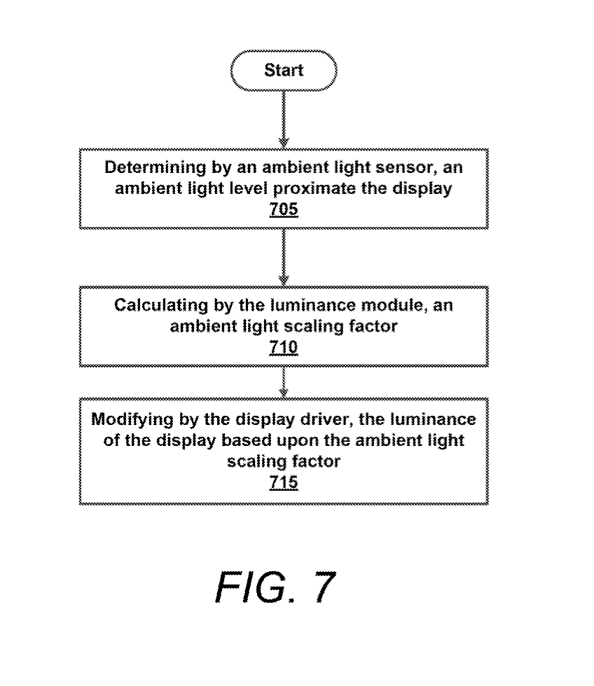

FIG. 7 illustrates an exemplary method for modifying a luminance of a display using an ambient light scaling factor. The method includes determining 705, by an ambient light sensor, an ambient light level proximate the display. The method may also include calculating 710 by the luminance module an ambient light scaling factor. Also, the method includes 715 modifying by the display driver, the luminance of the display based upon the ambient light scaling factor.

Thus, the method of FIG. 7 may be utilized in conjunction with either of the methods described with regard to FIGS. 4 and 5. That is, in addition to adjusting the luminance of the display using luminance control information, the luminance of the display may be further modified by applying ambient light scaling factor to the luminance control information, as described in greater detail above.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DUD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Embodiments of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method of adjusting a luminance of a display of a computing device based upon luminance control information of content presented on the display, the method comprising:
determining, by a luminance module in the computing device, luminance control information for the content, wherein the luminance control information is used to control a luminance of a display, and further wherein the luminance control information corresponds to brightness values of the content; and
adjusting by a display driver in the computing device, a luminance of the display during presentation of the content using the luminance control information.

2. The method according to claim 1, wherein the luminance control information is embedded into the content as metadata.

3. The method according to claim 1, further comprising:
receiving by a content buffer of the computing device, the content from a network; and
wherein determining luminance control information for the content comprises reading by the luminance module, the luminance control information from metadata of the content.

4. The method according to claim 1, further comprising receiving by the luminance module of the computing device, the luminance control information from a network on a control channel.

5. The method according to claim 1, wherein the luminance control information is specified by a content author.

6. The method according to claim 1, further comprising:
determining an ambient light level proximate the display via an ambient light sensor;
calculating an ambient light scaling factor by the luminance module; and
modifying by the display driver the luminance of the display based upon the ambient light scaling factor.

7. A method of adjusting a luminance of a display based upon content brightness of content stored by a computing device associated with the display, the method comprising:
scanning by a luminance module, content segments of the content to determine brightness values of the content segments, wherein the content segments are streamed to a buffer of the computing device;
calculating by the luminance module, luminance control information for the content from the brightness values of the content segments, wherein the luminance control information is used to control a luminance of a display; and
adjusting by a display driver, a luminance of the display during presentation of the content segments based upon on the luminance control information.

8. The method according to claim 7, wherein determining luminance control information for the content comprises:
generating by the luminance module, a brightness profile for the content; and
generating by the luminance module, a luminance script from the brightness profile; and
executing the luminance script by the luminance module to cause the display driver to adjust the luminance of the display while a content player application executing on the computing device presents the content for display.

9. The method according to claim 8, wherein the luminance script is keyed to time stamps of the content such that as the luminance module executes the luminance script, the luminance module causes the display driver to adjust the luminance of the display at each of the time stamps, wherein each of the time stamps comprises a luminance setting for the display.

10. A computing device for adjusting a luminance of a display based upon luminance control information of content presented by the display, the computing device comprising:
a luminance module configured to determine luminance control information for the content, wherein the luminance control information is used to control a luminance of a display, and further wherein the luminance control information corresponds to brightness values of the content;
a display driver configured to adjust a luminance of the display during presentation of the content based upon control signals received by the display driver from the luminance module; and
wherein the luminance module generates the control signals from the luminance control information.

11. The device according to claim 10, further comprising:
an ambient light sensor configured to sense an ambient light level proximate the display;
wherein the luminance module is further configured to calculate an ambient light scaling factor; and modify the control signals for the display driver based upon the ambient light scaling factor.

12. The device according to claim 10, further comprising a content buffer hat receives the content from a network on a content channel.

13. The device according to claim 10, wherein the display comprises a transparent display.

14. The device according to claim 13, wherein the luminance module is further configured to adjust a transparency of the content presented on the transparent display.

15. The device according to claim 10, wherein the luminance module receives the luminance control information from a network on a control channel.

16. A system for adjusting a luminance of a display based upon luminance control information of content presented on the display, the system comprising:
a computing device comprising:
a display driver configured to adjust a luminance of the display during presentation of the content; and
a luminance control module configured to control the display driver according to luminance control information, wherein the luminance control information corresponds to brightness values of the content; and
a network that streams the content to the computing device.

17. The system according to claim 16, wherein the network streams the luminance control information to the luminance module on a control channel.

18. The system according to claim 17, wherein the luminance module is configured to determine the luminance control information for the content by analyzing brightness values of images included in the content.

19. The system according to claim 16, wherein the network generates the luminance control information by analyzing the brightness values of images of the content.

20. The system according to claim 16, wherein the computing device also includes:
an ambient light sensor that senses ambient light proximate the display; and
wherein the luminance module is further configured to:
calculate an ambient light scaling factor; and
apply the ambient light scaling factor to control signals for the display driver such that the display drivers modifies the luminance of the display based upon the ambient light scaling factor.
